(19) United States
(12) Patent Application Publication
(10) Pub. No.: US 2008/0313074 A1
(43) Pub. Date: Dec. 18, 2008

(54) Business model that brings new technology to market in a rapid, cost effective manner

(75) Inventor: Douglas G. PLACEK, Yardley, PA (US)

Correspondence Address: OBLON, SPIVAK, MCCLELLAND MAIER & NEUSTADT, P.C., 1940 DUKE STREET, ALEXANDRIA, VA, 22314, US

(73) Assignee: ROHMAX ADDITIVES GMBH, Darmstadt (DE)

(21) Appl. No.: 11/761,694

(22) Filed: Jun. 12, 2007

(51) Int. Cl. G06Q 10/00; G06Q 40/00

(52) U.S. Cl. 705/39

(57) ABSTRACT

A system, model and method for commercializing a consumable product used in capital equipment by selling the consumable product in a first sale directly to a builder of capital equipment integrally with the sale of the capital equipment at a first price then making a second sale of the consumable product through a different sales path at a second price to a purchaser and/or operator of the capital equipment such that the second sale at the second price is sufficient to cover the development costs of the consumable product and generate a profit for a supplier of the consumable product.

### BACKGROUND OF THE INVENTION

1. Field of the Invention

A system, model and method for commercializing a consumable product or a technology that is used in a capital equipment article, including: first selling the consumable product and/or technology to a builder or supplier of the capital equipment article at a first price then selling the consumable product and/or technology at a second price to any one or more of the purchaser, manufacturer, supplier and/or reseller of the capital equipment article, where the second sale occurs through a different sales path than the first sale, and the second price is sufficient to generate a profit for the manufacturer, supplier and/or reseller of the consumable product and/or technology.

2. Description of the Related Art

A developer of a technology that is commercially manifested and/or embodied in the form of a consumable product may find it difficult to profitably commercialize and/or offer for sale the technology and/or consumable product if the consumable product is competing in an economic environment in which existing consumable products are already established in the market and/or are otherwise less expensive. Even though the existing consumable product may be inferior to the new consumable product in one or more aspects, the existing consumable product has the advantage of an established sales and market presence and market inertia, and is therefore difficult to displace in the market.

It is often difficult for the manufacturer, supplier or developer of the consumable product to convince consumers to change or try a new or unknown consumable product unless the consumable product and/or technology offers a significant benefit to the purchaser (e.g., the end-user). This is especially the case when the consumable product is an item that has some commodity characteristics or for which more than one alternative product is available. For example, in order to achieve market success, the consumable product must offer some significant improvement in economic performance or have properties and/or characteristics that give the consumable product one or more advantages over existing consumable products and/or features that distinguish the consumable product from generic products and/or substitutes.

This problem in commercializing consumable products and/or technologies is especially pronounced in industries where consumable products and/or technological improvements have historically been accepted slowly and/or where the market is highly price competitive. In the heavy equipment industry, an industry which manufactures, supplies, sells and/or leases capital equipment articles such as building equipment, bulldozers, cranes, farm implements, etc., the price of any individual capital equipment article is often more than $100,000. Although the price of any individual capital equipment article may appear high, a market environment that includes substantial competition between capital equipment manufacturers, suppliers and/or sellers and each sale is characterized by competition between several capital equipment suppliers can result in a low profit margin for a particular capital equipment supplier depending on the capital equipment manufacturer's market position. For some manufacturers, sellers and/or Teasers of capital equipment, substantial benefits (e.g., increased unit sales) could be realized if the capital equipment manufacturer and/or supplier could offer capital equipment articles at as low a price as possible.

The purchasers of capital equipment articles do not always place significant importance on improvements to existing consumable products that are used in existing capital equipment articles and/or the availability of entirely new consumable products when considering the purchase of a capital equipment article. This is especially the case if the improvement and/or new consumable product is not immediately apparent as a crucial element of the capital equipment article. A supplier and/or builder of capital equipment such as heavy building equipment may be more inclined to highlight technological improvements in capital equipment articles if the improvements are generated by an in-house design team and are readily apparent to the capital equipment purchaser, e.g., visible in the capital equipment article's design.

Improvements developed by the in-house design/engineering group of a capital equipment builder/supplier may generate a higher profit for any one of the capital equipment manufacturer, builder, supplier, seller or lessor in comparison to technological improvements made by one or more third parties. For example, improved technology that provides advantages such as longer battery life, longer tread wear, etc. may be promoted (e.g., advertised, marketed etc.) to a lesser extent by the seller of the capital equipment article. Third party technology improvements may also cause the capital equipment manufacturer, builder, seller, lessor and/or supplier to pay new or additional license and/or royalty fees.

Many different suppliers are used to provide parts and/or systems during the manufacture of many modern technologically advanced capital equipment articles. Each of the products, systems and/or technologies provided by a third party is developed by a company having a particular area of expertise. This is especially the case for capital equipment articles that involve many third party suppliers of subsystems such as for example brake systems, lighting systems, safety systems etc. Such third party suppliers must work closely with the builders/suppliers of the capital equipment articles in order to improve the chances of having any particular new or improved systems, technologies and/or consumable products approved for use (e.g., specified for use) in the capital equipment article by the capital equipment builders/suppliers.

In order to convince a capital equipment builder, e.g., an original equipment manufacturer (OEM), seller, lessor and/or supplier, to include a consumable product and/or a new technology as a component of a capital equipment article, the party developing the new technology and/or consumable product must be able to offer the new technology and/or consumable product at a price which balances the equipment builder/supplier's desire to be able to offer the capital equipment article at a low total market price with the desire to differentiate the capital equipment article by including the advantages, features and performance characteristics of a new technology and/or consumable product.

On the one hand, a capital equipment builder may prefer to offer a capital equipment article at a low price while concurrently constantly improving the capital equipment by including new technological advances and improved performance characteristics. The continuous improvement thus obtained may lead to improved profitability, e.g., improved unit sales and economy of scale. A capital equipment builder may be unwilling to include a new technology and/or consumable product as a component of a capital equipment article unless the inclusion of the new technology and/or consumable product does not lead to an overall price increase or decrease in profitability.

This need to commercialize new technologies and/or consumable products intensifies the commercial pressures on any third party developer who wishes to sell the new technology and/or consumable product directly or indirectly with the capital equipment article, i.e., as an installed component of the capital equipment article. For example, the development of a new technology and/or new consumable product, or the marketing of an existing consumable product, often requires significant development and/or marketing investment. The new technology and/or consumable product offered by the third party must be able to replace an existing technology and/or consumable product at a price that allows the third party to profitably market the new technology and/or consumable product without raising the overall cost of the capital equipment article in which the new technology and/or consumable product is sold.

A capital equipment purchase may be defined as the purchase of an article exceeding a certain price threshold. For example, the purchase of some capital equipment articles having a high price, e.g., over $50,000, is considered to be a capital purchase. There are, however, no definite price-based definitions that distinguish the purchase of a capital equipment article from the purchase of a consumable product. In some cases a capital equipment article may have a relatively low cost but is nonetheless treated as a capital equipment article.

Capital equipment articles are subject to different financing and accounting in comparison to lesser expensive items that are commonly used and/or consumed on a day-to-day basis. Such consumable products include many relatively lower priced products and materials that are used when heavy equipment is operated. For example, consumable items include components such as maintenance items including hydraulic oils, lubricating oils, gaskets, etc. The owner of a capital equipment article commonly spends less than $1,000 when purchasing a single consumable product to supply a capital equipment article whereas the cost of the capital article is substantially greater.

For accounting purposes the cost (e.g., outlay of cash, lease obligation or other continuing contractual obligation) of a capital equipment article may be depreciated over a number of years and may be charged against revenues over a like period. Consumable products on the other hand are treated as expenses which are charged against sales in the year of their use and/or purchase. The purchase of heavy equipment such as building equipment is typically financed and paid over a number of years whereas consumable products are typically paid for in cash and are rarely financed and, if financed, only for a short term.

Thus, a capital equipment purchase can be distinguished by the way its is treated for accounting and/or financing purposes.

Even though there may be substantial differences in the sale and/or use of capital articles in comparison to consumable products, both may share similar distribution channels. For example, capital equipment may be sold to a purchaser through a dealer. The dealer may also sell consumable products such as replacement parts, maintenance items and/or services. In this regard the distribution channel for the capital equipment article may be the same and/or similar to the distribution channel for a corresponding consumable product. While the distribution channel may be the same or similar, the sales path for capital equipment articles is usually different from the sales path for consumable products. For example, the purchase of a capital equipment article may involve certain representatives, e.g., employees, of the purchaser who have expertise in the selection, financing and payment of capital equipment articles. When a purchaser wishes to obtain a capital equipment article the purchaser may solicit sales bids (e.g., offers) from multiple suppliers, e.g., dealers and/or manufacturers of capital equipment. The purchaser may solicit bids each time a capital equipment article is purchased to determine the most price advantageous sale. In comparison, when a consumable product for use in a capital equipment article is purchased, the purchaser may carry out the selection of a seller, e.g., the bidding process, only one time (e.g., once annually) or the purchaser may leave the purchase decision to the discretion of one or more representatives responsible for purchasing consumable products. The sales path for capital equipment and consumable items may differ by, inter alia, (i) the frequency of offer solicitations, (ii) financing arrangements, (iii) accounting treatment, and/or (iv) the flow of organizational contacts between buyer and seller.

A supplier of an improved or new consumable product used in a capital equipment article is faced with the difficulty of offering the consumable product for sale to the capital equipment builder/seller at a price that allows its inclusion in the capital equipment article and which also permits the supplier of the consumable product to recover the consumable product's development costs and make thereby make a profitable sale. The consumable product supplier must be able to convince the capital equipment supplier to equip originally supplied capital equipment articles with the new consumable product and/or technology and thereafter require and/or recommend the use of the new consumable product and/or technology for future maintenance and/or replacement. The method, system and model of the invention addresses the aforementioned difficulties.

The model, system and method of the invention is different from many common business practices such as co-branding which have been used to sell and/or market new products according to a variable pricing schedule. For example, new consumable products are often launched by offering the consumable product at an initial price that is only a fractional amount of a target price, e.g., a retail or market price. In some cases the new consumable product is offered for free, i.e., it is made available at no cost in the hopes of attracting long term consumers. Examples of such product launches are commonplace for household products for example laundry detergents and razor blades. This pricing/marketing strategy for introducing a new product does not use a different sales path between the supplier of the consumable product and the purchaser of a capital equipment article and further does not require the integral sale of the capital equipment article with the consumable item.

Co-branding is often used to sell both capital equipment articles and consumable products. Co-branding is different from the model, system, and method of the invention because co-branding does not include different sales price levels set to cover the cost of developing a new consumable product and/or new technology. Moreover, co-branding does not necessarily involve different sales paths.

In other sales/marketing methods, an existing product is made available at a reduced price, e.g., a sales price, in order to improve or increase immediate sales. In such prior art processes, the first and second prices are not set to cover any new development costs associated with a new consumable product.

It is common for the supplier of a consumable product to offer the consumable product to a capital equipment builder/seller at a reduced price in comparison to the retail price for the same consumable product. However, the retail price of the consumable product in such a case is not set to take into account the development cost associated with the new consumable product. In the prior art processes, the first price, e.g., the sale of the consumable product to the capital equipment builder, is less than the retail sale price because the consumable product supplier is taking into account the economy of scale and/or convenience associated with supplying a large quantity of the consumable product to a single purchaser (i.e., the equipment builder).

### SUMMARY OF THE INVENTION

Accordingly, in order to find solutions to the difficulties in commercializing new technologies and/or consumable products, the inventors have described a method, system, and model by which consumable products, parts and/or subsystems of capital equipment articles may be commercialized.

It is one object of the invention to provide a method, system and/or model by which a new technology and/or new or existing consumable product may be commercialized.

It is a further object of the invention to provide a method, system and/or model by which a new consumable product for use in capital equipment may be commercialized.

It is a further object of the invention to provide a method, system and/or model by which the developer of a technology and/or consumable product may recoup development costs associated with the new technology and/or consumable product through secondary and/or replacement sales of the consumable product after a first sale made integrally with the sale of the capital article.

It is a further object of the invention to provide a method, system and/or model for launching new product technology and/or new consumable product.

It is a further object of the invention to provide a method, system and/or model to speed the commercial introduction of a new technology and/or consumable product used in a capital equipment article.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings which may show aspects of the method, system and/or model of the invention, and wherein:

FIG. 1 shows product and revenue flows between the developer of a new technology (oil marketer) and the supplier of a capital equipment article (bulldozer EB/OEM);

FIG. 2 shows the product and revenue flows between the developer of a new technology and the supplier of a capital equipment item and includes direct sales between the developer of the new technology and the ultimate owner of a capital equipment article purchased from the supplier of the capital equipment article;

FIG. 3 shows product and revenue flows between the developer of a new technology and a supplier of a capital equipment article and includes brand and/or technology licensing to an intermediary that acts between and/or with the technology developer and the capital equipment supplier;

FIG. 4 shows the product and revenue flows between multiple suppliers of a capital equipment article and the developer of a new technology and/or consumable product through multiple sales and/or supply points; and

FIG. 5 shows the product and revenue flows between multiple suppliers of a capital equipment article and a plurality of suppliers of a consumable product including more than one retail supplier.

### DETAILED DESCRIPTION OF THE INVENTION

Any of the method, system and model of the invention may be used to commercialize a consumable product and/or a new technology. Commercializing a consumable product or new technology allows the consumable product or new technology to be available to many new users who would otherwise not have access to the consumable product or the new technology. Commercializing a new consumable product or technology provides substantial benefits to the developer of the consumable product or technology by allowing the developer to recoup development costs. Additionally, the benefits associated with a consumable product and/or new technology are utilized for the benefit of many individuals and society at large. Commercializing a consumable product or new technology that offers societal benefits such as reduced pollution, greater reliability and improved efficiency benefits many people other than the consumable product supplier in ways unrelated to the profitability of any particular commercial entity.

The method, system and model of the invention can be implemented in the business practices of both developers of new technology and the suppliers/manufactures of capital equipment. By using the invention such parties can maintain economic health and thereby provide employment for their respective employees. By commercializing a consumable product or new technology, the method, system and model of the invention are able to accomplish a result that may not always be possible with conventional marketing techniques which are oriented towards immediate and/or short term economic benefit.

The method, system and model of the invention may be carried out on any of a consumable product and a new technology. The consumable product does not necessarily have to be a new consumable product. In some instances, the consumable product may be an existing consumable product that offers benefits and advantages over competing consumable products however conventional marketing techniques are not successful for one or more reasons such as the market inertia of an established consumable product, lack of marketing resources, and other commercial reasons.

A consumable product is an item or article of manufacture that is traded in commerce. A consumable product is a tangible item consisting of individual units that may be divisible depending upon how the consumable product is packaged. Consumable products may take many forms including solids, liquids and gases. A consumable product may be a new consumable product having features and/or characteristics that previously did not exist for similar conventional consumable products. A new technology may be included as a feature of a consumable product. A new technology may also be a software program or other product that is not necessarily embodied in tangible form.

The consumable product or new technology of the invention is preferably sold integrally with a capital equipment article. An integral sale is one in which two different products and/or a product and a technology are sold to an end-user as a single package in a manner such that the purchaser is aware that only a single sale is taking place. For example, an automobile is typically sold in an integral manner with motor oil. The purchaser of an automobile equipped with motor oil is viewed as a single sale, not two sales, e.g., the separate sale of the automobile and the motor oil. An integral sale does not require the inclusion of any particular amount of a consumable product; however, typically, an integral sale combines a capital equipment article with a sufficient amount of the consumable product to carry out operation of the capital equipment article for a period of time that is typically greater than at least one cycle of use of the capital equipment article. A cycle of use is the period of time in which a capital equipment article can be operated on a continuous, near continuous or semi-continuous basis without recharging or refueling.

As used herein the term “capital equipment article” refers to an article that may be treated as a depreciable asset for accounting purposes. The period of depreciation for the capital equipment article may be fixed or variable. The period of depreciation may vary according to applicable accounting rules but is typically longer than one year because a capital equipment article has a useful life of longer than one year. Other periods of depreciation include periods of 3, 5, 7, 10, 20 and 30 years with all ranges, multiples and subranges of the stated values expressly included. The capital equipment article may be purchased through a finance agreement whereby the capital equipment serves as security for any amount borrowed to purchase the capital equipment item. In other aspects a capital equipment article is equipment which has an extended life so that it is properly regarded as a fixed asset. In the context of the invention capital equipment articles do not include real property (e.g., land or real estate). A depreciable asset is an asset that may be a capital equipment article whose value decreases as it is used or as it ages.

The term “new technology” as it is used herein identifies a new product, service, method, improvement, or item that has not previously been commercialized and/or has not previously been available for sale through a supplier of capital equipment. Preferably, the new technology is patentable. Preferably the new technology is a new, improved or existing consumable product that is used and/or consumed in conjunction with the operation of a capital equipment article. The new technology preferably has a separately calculable development cost that is distinguishable from the development cost of any existing or old technology that the new technology is replacing.

The term “sales path” as it is used herein describes the route by which a good or service is transferred from a manufacturer/supplier to an intermediary or an end-user as part of a commercial transaction by which the owner of the consumable product and/or new technology. A sales path may be defined by the individuals within the organizations representing the buyer and seller of, for example, a consumable product or a capital equipment article. The sequence of contacts of an organization may define a sales path (e.g., the sales path for purchaser of a capital equipment article may be defined as step 1—request from field engineer, step 2—define requirements by internal engineering, step 3—budgeting by accounting, step 4—request for bids by purchasing, step 5—obtain funds for purchase by financing department, step 6—receipt and quality confirmation).

The term “development cost” as it is used herein is the investment required to develop and/or market a product, preferably a new consumable product and/or technology. Preferably the consumable product and/or technology is used and/or consumed during the operation of a capital equipment article. Development costs may include any of the costs incurred to develop and commercially market a consumable product and/or technology. Past and/or future costs may be included. For example research and development, marketing, reliability testing, field testing, manufacturing expansion costs, capital investment, and the development of a supply chain or a distribution chain. Developments usually do not include any of the variable costs associated with manufacturing or producing a new technology and/or consumable product. Preferably the development cost of a new technology or a consumable product is the total cost of research, development, marketing, administrative and other costs directly associated with the commercialization of a new technology or consumable product.

When used to describe the invention, the term “consumable product” is a component of a capital equipment article that may be periodically replaced due to wear and tear, or due to exhaustion. For example, consumable products include the components need to operate the capital equipment including maintenance items such as hydraulic oils, lubricating oils, etc. A consumable product is one that must be present in order to operate capital equipment articles. A consumable product is not necessarily replaced with each use but instead has a variable or finite lifetime that may be defined by time or by the condition of the consumable product and/or the condition of the capital equipment article. Within the system, method and model of the invention, a consumable product is not an item such as fuel which is used only once and which is exhausted immediately upon use. The consumable product of the invention is preferably a functional fluid, a hydraulic fluid or a lubricating oil that is used when operating heavy machinery such as bulldozers.

In a different aspect of the invention, a consumable product may represent a product that is used in conjunction with another article and/or service that may not be a capital equipment article but nonetheless requires the co-use of the consumable product in order to function. For example, a floppy disk, CD or battery may each represent a consumable product for a laptop computer or electronic entertainment device even if the laptop computer or entertainment device has a financial life of less than one year and is not otherwise classified as a capital equipments article under applicable accounting rules.

A supplier of a new technology and/or consumable product is the entity that developed, manufactured, and/or marketed the new technology and/or consumable product. The supplier may be an entity that markets components of the consumable product obtained from other suppliers, entities or parties. The supplier may be an entity that purchases components from a plurality of other suppliers and blends or manufactures a consumable product by combining the components provided by the other entities. The supplier may provide one or more components of the consumable product, for example the supplier may manufacture one component of the consumable product in-house and combine it with one or more other components supplied by one or more other suppliers. Preferably the supplier is an entity that manufactures the consumable product. The supplier is preferably an entity that is different from a supplier and/or builder of the capital equipment and is subject to different ownership.

The term depreciation as it is used herein represents the economic value of the exhaustion, wear and tear, and/or obsolescence that occurs when a capital equipment article having a useful life of greater than one year is used. There are different ways to calculate and account for the value of depreciation of a capital equipment article within the scope of the invention. One method is straight line depreciation where equal increments of the value of the capital equipment article are treated as an expense. The beginning value of the capital equipment article represented by its purchase price and/or fair market value is the basis from which equal increments of economic value are expensed and/or subtracted. Capital assets and/or equipment articles may be given different lifetimes depending on accounting and/or tax requirements. For example, in some cases, expensive capital equipment articles may have a lifetime of three years. In other cases a useful life of as long as 30 years may be used for depreciation purposes.

Depreciation may be calculated based on the actual use and/or decrease in value of the capital equipment article. Similarly, depreciation may be based upon volume usage where the amount of depreciation increases as a function of the total amount of use, e.g., the amount of production. In such an instance, a capital equipment article such as a bulldozer which has undergone little use has a variable annual depreciation that is measured by the difference in the fair market value of the asset (e.g., the capital equipment article) at the beginning of the fiscal year relative to the fair market value at the end of the fiscal year.

Accelerated depreciation may also be used. In accelerated depreciation the amount of depreciation of a capital equipment article may change on an annual basis but the annual amounts of depreciation are known in advance according to a schedule. The initial amounts that may be expensed are disproportionately large in comparison to the annual increments of depreciation over time.

All of the above-mentioned methods of depreciation are included in the invention and any method(s) of depreciation may be used to value the capital equipment article of the invention and its corresponding amounts and rates of depreciation. The methods of depreciation may further be used to determine whether or not the sale of a consumable product is one that generates a profit.

In a one aspect of the invention, a supplier of capital equipment is an equipment builder. The equipment builder is an entity such as a corporation that develops, designs, manufactures, and/or markets capital equipment for sale or resale. The equipment builder is an entity that is responsible for defining the operating specifications for the capital equipment. The operating specifications can include any of the operational limits, maintenance requirements, and functional characteristics of the capital equipment.

The equipment builder preferably issues a warranty for the capital equipment articles it sells. The warranty defines those actions required by the purchaser and/or operator of a capital equipment article that must be undertaken in order to obtain the benefit of the warranty. The warranty includes specifications defining any one or more of the source, composition, and/or operating conditions for consumable products that are required to operate the capital equipment article. For example, an equipment builder may define the type of hydraulic oil that may be used when operating a capital equipment article such as a bulldozer. The hydraulic oil specification may define parameters such as sulfur content, viscosity, oxygen content, fire resistance, lifetime, etc. Specifications may be issued by the equipment builder for any, a portion, or all of the consumable products required to operate the capital equipment article. Such specifications may include established local, regional, or industry specifications, such as ASTM, ISO, DIN, JCMAS, as well as specific OEM specs among others. Preferably the equipment builder provides specifications for hydraulic oil used during operation of a bulldozer. Hydraulic oil includes hydraulic fluids, lubrication fluids and functional fluids.

A purchaser and/or operator of the capital equipment is incentivized to strictly follow the specifications issued by the equipment supplier in order to obtain the protection provided by the equipment supplier's warranty. If the purchaser and/or operator of the capital equipment uses the capital equipment in a manner inconsistent with the requirements of the warranty and/or uses consumable products that do not meet the specifications of the warranty, the purchaser of the capital equipment may forfeit some or all of the benefits provided by the warranty.

The equipment builder specifies the consumable products in a manner such that improved performance is obtained from the capital equipment. For example, in the case of hydraulic fluids used in bulldozers, the use of hydraulic fluids having certain additives and/or heat resistance properties may substantially increase the service life of the capital equipment's hydraulic components, such as gasket materials. Preferably, the use of the specified hydraulic fluid provides the purchaser and/or operator of the capital equipment with advantages such as longer service life, lower cost of service, longer lifetime and reduced maintenance costs, longer time between maintenance intervals, improved performance efficiency in terms of power, speed, noise, energy efficiency, and emissions.

In this aspect of the invention a supplier of a new technology and/or consumable product, preferably a new consumable product such as a hydraulic fluid, makes the consumable product available to a capital equipment supplier at a first price that is not higher than and preferably lower than the price paid by the equipment supplier for the existing, prior art, generic or standard consumable product. Preferably the price of the capital equipment is not affected by the inclusion of the new consumable product so that the total cost contribution of the consumable product and/or new technology to the capital equipment item has not increased and/or changed. More preferably, the supplier of the new technology and/or consumable product makes the consumable product available to the equipment builder at a price that is lower than the price of the consumable product of existing and/or competing technology and/or products, or the supplier of the new consumable product makes the consumable product available to the equipment builder for free. The supplier of the capital equipment is thereby able to offer the capital equipment for sale with the new consumable product and/or technology already installed but without any price increase relative to the price of the capital equipment article containing any alternate technology and/or consumable product.

The equipment builder is able to sell the capital equipment by advertising the advantages provided by the new technology and/or consumable product without having to increase the price of the capital equipment article. Preferably the capital equipment supplier is able to maintain an existing price and/or decrease the existing price of the capital equipment article.

The supplier of the new consumable product and/or technology thereby makes a first sale of the new technology and/or consumable product to the capital equipment supplier/builder at a first price (P1). The first price of, e.g., the consumable technology, may not be sufficient to generate a profit based on the net difference between the total cost of the consumable product (e.g., including development and marketing costs and/or generally overhead costs) and the sales price.

The cost of the consumable product is the total cost including development cost. Profit is calculated by determining the total cost of the consumable product and/or technology including all development, marketing, product introduction, raw material, manufacturing, fixed, variable, overhead, sales, marketing, and administration costs; and subtracting the sum of these costs from the sales price. The first sale may be conducted at a price P1 that is not high enough to yield a profit, e.g., the sales price does not cover all of the product's costs.

Preferably an agreement exists between the equipment builder and the supplier of the consumable product whereby the equipment builder agrees to issue a specification requiring that future replacement and/or replenishment of the consumable product must meet certain performance characteristics and/or properties. In one embodiment the warranty for the capital equipment article is not fully enforceable unless the capital equipment article is serviced with materials that meet the warranties requirements. Performance characteristics and/or properties include those which may typically be used to define a consumable product. For example, in the case of a hydraulic fluid, the specifications may include established local, regional, industry specifications, such as ASTM, ISO, DIN, JCMAS, as well as specific OEM specs, viscosity, fire resistance, density, pour point, flash point, FZG Gear Test, DIN 51534, Vickers I-286-S, Vickers M-2950-S and resistance to thermal degradation.

Preferably one or more of the specifications is met by products produced by other suppliers of consumable products. Multiple suppliers are preferred such that the supplier of the consumable product is not the only supplier of a consumable product that meets the equipment builder's specification and/or warranty requirements. The developer of a consumable product and/or new technology may have an agreement with the equipment builder to provide the consumable product at certain prices; however, other manufacturers of other consumable products that utilize different technologies may still be in a position to supply a consumable product meeting the equipment builder's specifications. Preferably, the specification issued by the equipment builder does not require the purchaser to use any particular brand or manufacturer of the consumable product but instead requires only that the consumable product meet certain performance and/or property characteristic requirements.

Because the consumable product must be replaced and/or replenished over time, the purchaser and/or operator of the capital equipment will necessarily need to purchase additional amounts of the consumable product in the future. The purchaser and/or operator of the capital equipment may obtain the consumable product through many different sources, locations, or suppliers. Preferably the purchaser and/or operator of the capital equipment article obtains replacement and/or replenishment quantities of the consumable product at a location or through a source recommended by the equipment supplier. The purchaser and/or operator of the capital equipment article may also purchase the consumable product at retail suppliers that may be affiliated with the equipment supplier.

The purchase of replacement and/or replenishment quantities of the consumable product are made by the purchaser and/or operator of the capital equipment at a second price P2 thus resulting in a second sale of the consumable product. The price P2 is preferably greater than the price P1 of the first sale. The second price P2 may generate a profit for the supplier of the consumable product if sufficient quantities are sold. The price P1 and P2 may vary over a large range but usually the price P1 is less than the price P2. The difference between price P1 and P2 may be 10%, 20%, 30%, 40%, 50%, 60%, 70%, 80%, 90%, 100%, 125%, 150%, and/or 200% (all values, sub-ranges between the stated values and any multiples or fractions thereof are expressly included), or greater than any of the aforementioned differences.

The first and second prices P1 and P2 may be modified by the party selling the consumable product to the capital equipment builder, purchaser and/or operator. For example the supplier of the new consumable product and/or technology agrees to sell the new technology and/or consumable product to the capital equipment supplier/builder according to a mutually agreed on price schedule that includes one or more rebates. The rebate is a discount assessed on prior sales of the consumable product made by the capital equipment builder and/or purchaser. A capital equipment builder and/or purchaser may agree to sell a first amount of consumable product at a first, variable price P1 and a second amount of the consumable product at a second price P2. The price P1 varies according to a schedule of sales detailed in an agreement between the capital equipment builder and/or purchaser and the seller of the consumable product.

Typically the capital equipment builder and/or purchaser will receive a retroactive discount on the first price P1 on meeting certain sales goals, milestones, thresholds and/or quotas (e.g., sales level). After reaching an agreed on sales level, the seller and/or supplier of the consumable product returns an amount of the first price to the capital equipment builder and/or purchaser. The amount of the first price returned to the capital equipment builder and/or purchaser is usually a fractional amount that is tied to the amount of consumable product sold at the second price P2. The rebate may be provided as a cash payment or as a credit applicable towards future sales of the consumable product. In another embodiment of the invention the rebate is applied to prior, future or both prior and future sales occurring at the second price P2. Preferably, the rebate is expressed as a percentage, e.g., a 1, 2, 3, 4, 5, 10, 15, 20% (all sub-ranges, multiples and fractions of the stated numbers are expressly included) reduction in the price P1 and/or P2.

The sale of the consumable product to any of a builder, purchaser and/or operator of the capital equipment article may occur directly through the consumable product supplier, an agent of the consumable product supplier, an independent retailer, and/or a distributor having an agreement with the consumable product supplier. Preferably, the consumable product supplier is the entity that developed, designed and manufactured the consumable product and/or technology. Preferably the sale of the replacement and/or replenishment amounts of the consumable product occur through the equipment builder (e.g., OEM sale).

Whether the sale of a consumable item at a particular price, e.g., a price P1 and/or a price P2, is profitable depends upon many factors including the method of calculating profitability. The term profit as used herein means net profit. Net profit is the difference calculated of the sales price of the consumable product, e.g., revenue, obtained by selling the consumable product to the operator of the capital equipment minus the total cost of the consumable product. The total cost of the consumable product includes all costs such as wages, rent, raw materials, interest, overhead, research and development, taxes, sales and depreciation. Because some costs such as interest and depreciation may have a substantial affect upon profit, it is preferred that the profitability of any particular sale of the consumable product is based upon an assumption that the plant or manufacturing facility used to manufacture the consumable product is operating at 100% capacity. General, selling and administrative costs are subtracted from revenues in order to determine the net profit.

In the model, system and method of the invention, there is no requirement that the equipment builder and the consumable products supplier disclose to one another the cost and/or revenues associated with the sale of either the consumable product or the capital asset. Preferably, both parties keep such information confidential.

The invention includes embodiments where for example the equipment manufacturer buys a consumable product from a consumable product supplier a both a price P1 and a price P2. In at least this embodiment the equipment builder and the consumable product supplier disclose prices P1 and P2 to each other.

In the system, model and method of the invention the first and second sales of the consumable product are made through different sales paths. The first sale of the consumable product is made directly to an equipment builder (e.g., a builder or manufacturer of a capital equipment article) or a supplier of capital equipment. The ultimate purchaser of a capital equipment article is not directly involved in the choice or selection of the consumable product in this first sale. While it is possible that the purchaser of the capital equipment article may choose to purchase a particular capital equipment article based only on whether the consumable product is included, other determinants of the purchaser's decision will relate to the functionality and/or hardware characteristics of the capital equipment article. In some cases, during the purchase negotiations for the capital equipment article there is no mention of the consumable product other than its appearance in the maintenance specifications of the capital equipment article.

The sales path of the first sale may be a direct sale occurring between the manufacturer of the consumable product and the manufacturer/builder of the capital equipment article. Other parties may participate in the first sales path, for example a distributor may act as an intermediary between the manufacturer of the consumable product and the equipment manufacturer/builder. In other instances, one or more parties may manufacture the consumable product under license and subsequently sell the consumable product either directly to the equipment builder or to one or more intermediaries who subsequently supply the consumable product to the equipment builder. Preferably, the sales path of the first sale includes only the manufacturer of the consumable product and the equipment builder, and the sale is made directly between these two parties in the absence of any intermediary.

The sales path for the first sale of the consumable product is complete after the consumable product is sold to an equipment builder. The second sale is usually not completed until after the capital equipment article has been purchased and/or leased to a purchaser and/or operator of the capital equipment article.

The sales path for the sale and/or lease of the capital equipment may take place directly between the equipment builder and the purchaser of the capital equipment. This sales path may involve several parties. In one embodiment of the invention the equipment builder sells the capital equipment directly to a purchaser. The purchase is made without any intermediary. Preferably, the purchase of the capital equipment occurs through a dealership, retailer, partner and/or third party acting as an agent for the equipment builder. The party selling the capital equipment to the purchaser preferably completes the sale through a sales team or one or more representatives who are specially trained and knowledgeable with regard to the sale, use, maintenance and features of the capital equipment. Preferably, the sale is made by a group of one or more individuals whose sold responsibility is the sale of capital equipment.

In other embodiments the equipment builder uses an intermediary such as a dealer to sell the capital equipment to the purchaser. A dealer or an agent provides direct contact between the equipment builder and the purchaser. Other intermediaries and/or parties may also play a role in the sale of the capital equipment. Such other intermediaries may represent one or more additional nodes in a sales path. For example, the capital equipment may be sold through an auction or blind bidding process, e.g., through an automated auction system.

The sales path for the purchase of the capital equipment must include the purchaser and/or operator of the capital equipment. The purchaser may be a private individual or a representative of an organization such as a corporation or government. Preferably, the purchaser is an individual employed by an entity purchasing or leasing the capital equipment and who has responsibilities dedicated to one or more of selecting equipment for purchase, negotiating the purchase of capital equipment and planning capital equipment purchases. The representative of the capital equipment purchaser will typically be in direct contact with the individual or party representing the equipment builder/seller. Because the purchase of capital equipment may require a substantial amount of capital, a financial controller and/or representative of any organization providing capital to complete the purchase of the capital equipment may be present or may provide advice and/or consent before the purchase of the capital equipment is completed.

The second sale of the consumable product has a different sales path than the first sale of the consumable product. The sales path of the second sale of the consumable product may take place without any involvement of the equipment builder or equipment supplier. The second sales path may instead go through a retailer and/or distributor who carries an inventory of the consumable product and offers it for sale at a price that is different from the price of the first sale P1 and the price of the second sale. In addition or in the alternate, the purchaser and/or operator of the capital equipment may purchase the consumable product directly through the representative of the equipment builder from which the capital equipment was purchased. Preferably the consumable product is sold by the equipment builder or equipment supplier directly to the equipment purchaser. Preferably sales of the consumable product between the equipment builder or equipment supplier and the equipment purchaser are for a branded product, e.g., the consumable product is packaged with labeling that identifies the equipment builder or equipment supplier as the source of the consumable product or is branded with the equipment builder's or equipment supplier's mark such as a registered trademark or a mark used in commerce.

Regardless of the exact sales path, the second sale of the consumable item is made by the supplier of the consumable product at a second price P2. The second sale of the consumable product may take place directly between the buyer of the capital equipment and the supplier of the consumable product. Preferably the second sale is made between the supplier of the consumable product and one or more intermediaries at the second sales price P2.

The second price P2 is different than the first price P1 that is paid by the equipment builder to the supplier or manufacturer of the consumable product. The second price P2 at which the consumable product supplier sells the consumable product is set so that the second sale is profitable assuming that the manufacturing facility producing the consumable product is operating at 100% capacity, e.g., whereby all costs of supplying the consumable product are spread evenly over all sales.

By using the first and second sales prices, the supplier of the consumable product is able to effectively commercialize a consumable product and/or a new technology, e.g., profitably introduce a new technology and/or consumable product into the market. By selling the consumable product at the first sales price P1, the consumable product supplier allows the equipment builder and/or seller of capital equipment to offer a capital equipment article for sale at a price that is not burdened with the development costs of the new technology and/or consumable product. The seller of the capital equipment article is thereby able to advertise the benefits associated with the new technology and/or consumable product as a desirable feature of the capital equipment article without changing the pricing scheme for the capital equipment article. The development costs of the new technology and/or consumable product are covered later by the second sale of the consumable product which is completed at a sales price P2.

The method, system and model of the invention provide a way to introduce a new technology and/or consumable product to capital equipment purchasers and operators of capital equipment in a manner that that does not require the consideration of the capital equipment purchaser at the time the capital equipment is purchased. The capital equipment purchaser later purchases additional amounts of the consumable product and pays an additional amount associated with a second sale only after the purchaser and/or operator has already realized the benefits provided by the consumable product and/or technology, e.g., by using the capital equipment that has been pre-supplied and/or pre-filled with the consumable product from the equipment builder.

The specification issued by the equipment builder to the purchaser of the capital equipment encourages the purchaser and/or operator of the capital equipment to utilize the new consumable product for maintaining and/or refilling the consumable product in the capital equipment.

The method, system and/or model of the invention can be applied to a wide variety of products including the consumable or routinely replaced components used in the following applications and equipment:

Electronics—Cameras, Mobile telephones, Stereos, DVD/CD/Tape players.
Film, data storage media, batteries
   Computers—Desktop computers, Laptop computers
Data storage media (DVD, CD, USB storage cards, chips, disks)
   Computer peripherals—Printers, Data storage media,
Ink cartridges, printing media, paper, labels
   Automobiles—Cars, trucks, buses,
Lubricants, functional fluids, coolants, greases, tires, wiper blades, belts, hoses, seals, cleaners, polishes, filters, brakes, lighting elements

### Trains, Airplanes, Ships—

Lubricants, functional fluids, coolants, greases, wheels, belts, hoses, seals, cleaners, polishes, filters, brakes, lighting elements
   Heavy Duty Equipment—Hydraulic equipment, Cranes,
Lubricants, functional fluids, coolants, greases, wheels, tires, tracks, implements, belts, hoses, seals, cleaners, polishes, filters, brakes
   Medical devices—
Seals, hoses, paper, data storage media, batteries, syringes, sample collection or storage
   Home Appliances—Washers, Dryers, Refrigerators, Vacuums, Sweepers, Mops, Brooms, Lighting fixtures, flashlights
Seals, hoses, paper, data storage media, batteries, cleaning materials, light bulbs, lighting elements

### Personal Care—Shaving,

Razor or cutting blades

### EXAMPLES

### Example 1

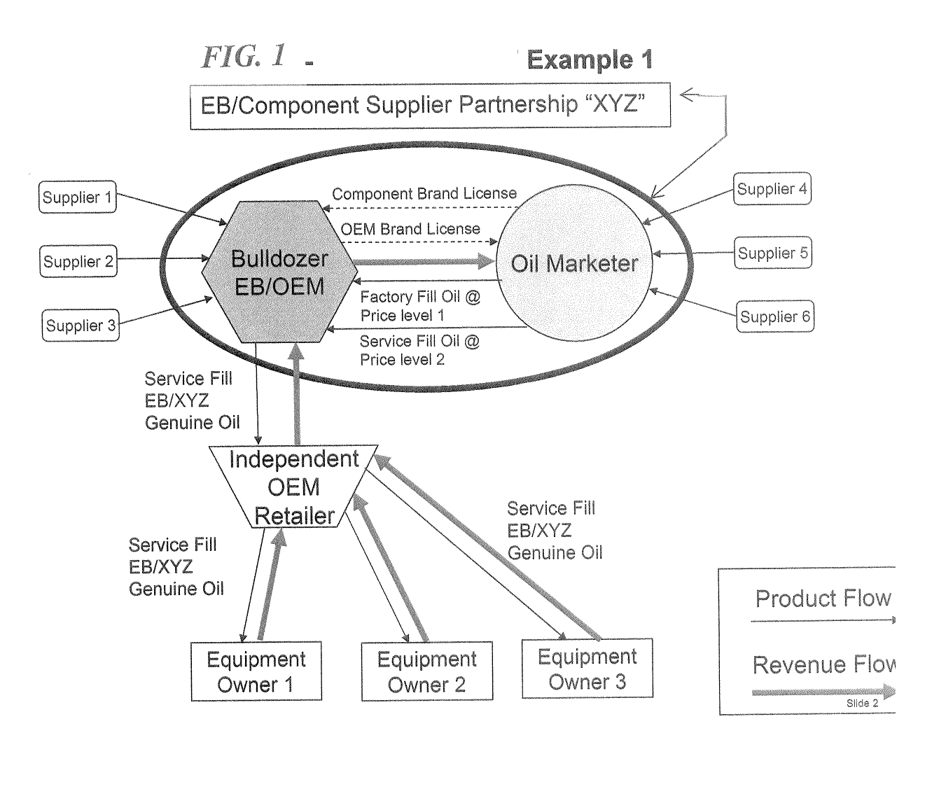

(See FIG. 1) A manufacturer of heavy duty construction bulldozers purchases hydraulic fluid (e.g., oil) for each new article of capital equipment (i.e., each bulldozer) assembled in the manufacturer's factory. The bulldozer manufacturer also purchases hydraulic fluid for sale to its independent retailers as a company branded maintenance item. The retailers sell the company branded hydraulic fluid, offering customers the assurance that they are using a “genuine” replacement part. The hydraulic fluid is consumable because it must be replaced and/or replenished according to a maintenance schedule set by the bulldozer manufacturer.

An oil marketer develops a new specialty hydraulic fluid that improves fuel efficiency. In order to generate profitable sales the new hydraulic fluid must be sold at a price that is 50% more than the standard hydraulic fluid that it is replacing, and thus the bulldozer manufacturer is reluctant to use the new product.

The bulldozer manufacturer and the oil marketer form a partnership. The oil marketer gives the new specialty hydraulic fluid to the builder for the same price as the price of the existing hydraulic fluid technology, for use as factory fill oil in all bulldozers. The bulldozer manufacturer creates and publishes a specification for the new hydraulic fluid. The bulldozer manufacturer requires the use of the new specification hydraulic fluid for all future service fills. The bulldozer manufacturer purchases the hydraulic fluid to be re-sold for a service fill at a price that is 75% higher than the previously used hydraulic fluid. The higher price is passed onto the retail distributor, and ultimately onto the equipment owner (i.e., the party who purchased the bulldozer from the bulldozer manufacturer and operates the bulldozer in commerce). The oil marketer is compensated for the factory fill oil sale which occurs at a lower price than the service fill through a higher profit margin on the service fill hydraulic fluid. The equipment owner receives the benefit of the higher performing hydraulic fluid that delivers fuel efficiency, and thereby lowers the equipment owner's overall cost of operation and/or provides features or advantages not available through the previous hydraulic fluid technology. Bringing the technology to market in a more rapid manner improves the overall productivity of the equipment, and also reduces fuel consumption and exhaust emissions.

### Example 2

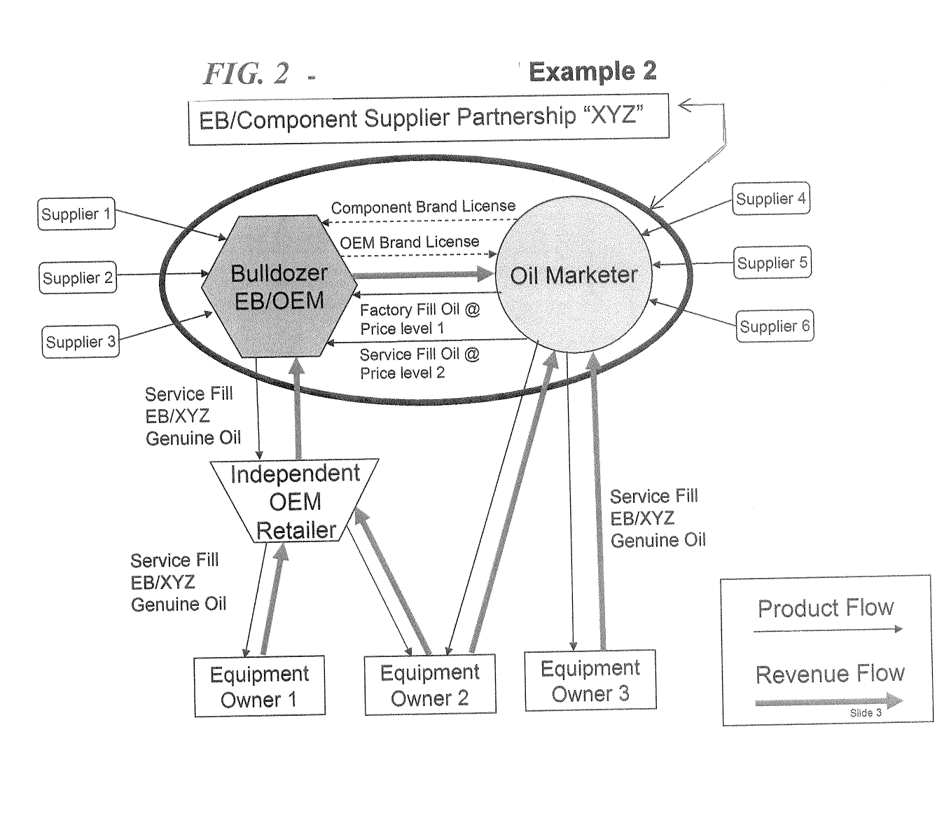

(See FIG. 2) Similar to Example 1, with the added feature that the partnership allows the oil marketer to directly sell the genuine service fill hydraulic fluid.

### Example 3

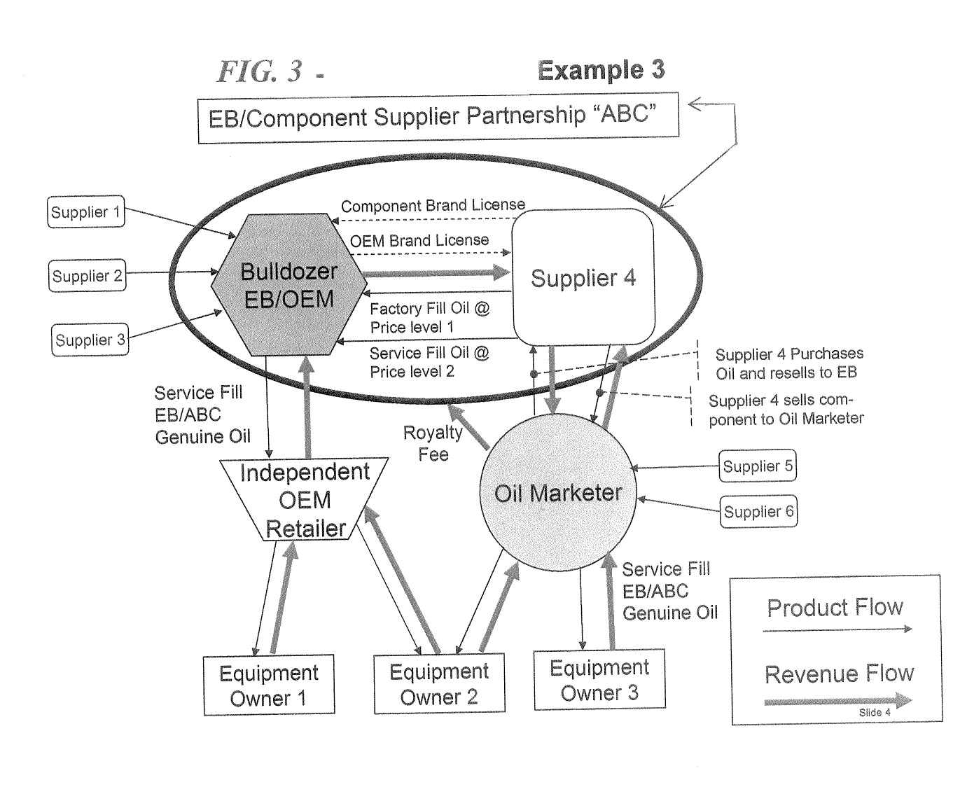

(See FIG. 3) A manufacturer of heavy duty construction bulldozers purchases hydraulic fluid for each new piece of equipment assembled in a factory. The bulldozer manufacturer also purchases oil for sale to its independent retailers as a company branded maintenance item. Retailers sell the company branded hydraulic fluid, offering customers the assurance that they are using a “genuine” replacement part.

A component supplier to the oil marketer develops a new additive technology that allows for the formulation of a new specialty hydraulic fluid that improves fuel efficiency. The use of the new additive in the formulation increases the price by 50% that must be charged in order for the new specialty hydraulic fluid to be sold profitably, compared to the standard hydraulic fluid. Due to the increased cost, the bulldozer builder is reluctant to use the new product.

The bulldozer manufacturer and the additive component supplier form a partnership. The additive component supplier has the hydraulic fluid toll manufactured by an oil marketer, and sells the new specialty hydraulic fluid to the bulldozer manufacturer for the same price or a lower price than the price of the existing hydraulic fluid technology, or provides the hydraulic fluid to the bulldozer manufacturer for free, for use as factory fill oil in all bulldozers. The bulldozer manufacturer creates and publishes a specification for the new hydraulic fluid. The bulldozer manufacturer requires the use of the new specification hydraulic fluid for all future service fills. The bulldozer manufacturer purchases the hydraulic fluid to be re-sold for service fill from the additive supplier at a price that is 75% higher than the current standard hydraulic fluid. The higher price is passed onto the retailer distributor, and ultimately onto the equipment owner. The additive component supplier is compensated for the free factory fill oil through a higher profit margin on the service fill oil. The equipment owner receives the benefit of the higher performing oil that delivers fuel efficiency, and thereby lowers the equipment owners overall cost of operation.

There is also the option for the partnership to grant a license to one or more oil marketers, enabling the oil marketer to sell the new branded hydraulic oil directly. The partnership would develop a licensing fee or royalty payment structure on the amount of hydraulic fluid sold by the oil marketer.

### Example 4

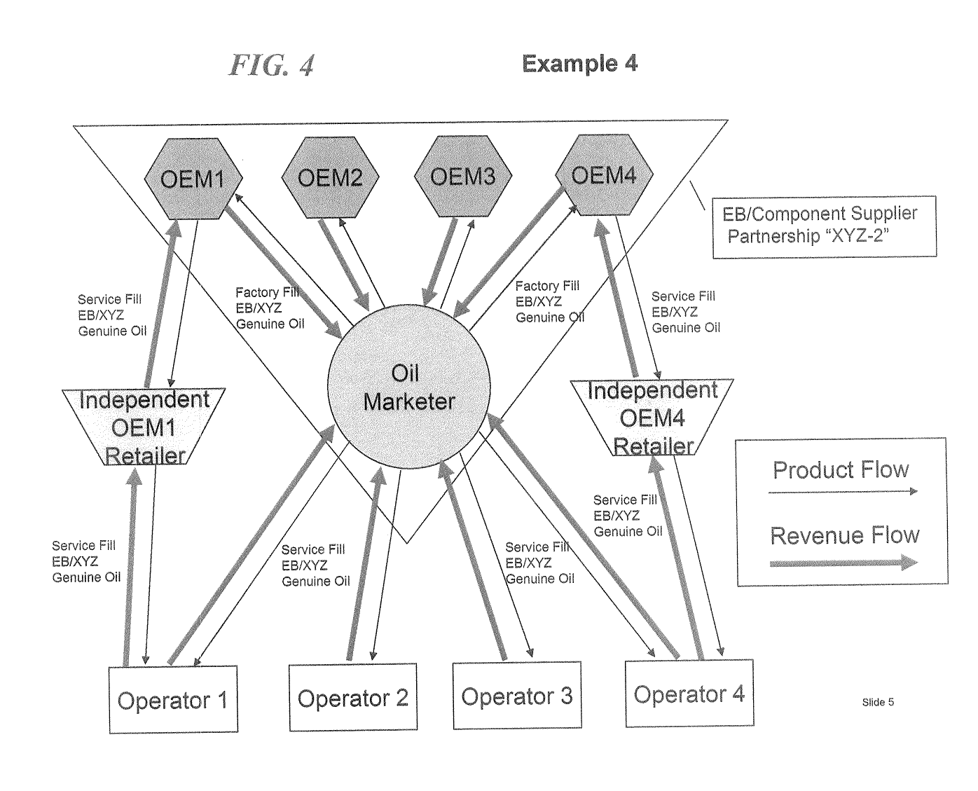

(See FIG. 4) Similar to Example 2, with the added feature that the partnership involves a number of equipment builders who seek an arrangement where they receive free factory fill hydraulic fluid. The consortium partnership selects and endorses a shared specification for the hydraulic fluid. The partnership enables the oil marketer to directly sell the genuine service fill oil endorsed and specified by the equipment builders in the partnership

### Example 5

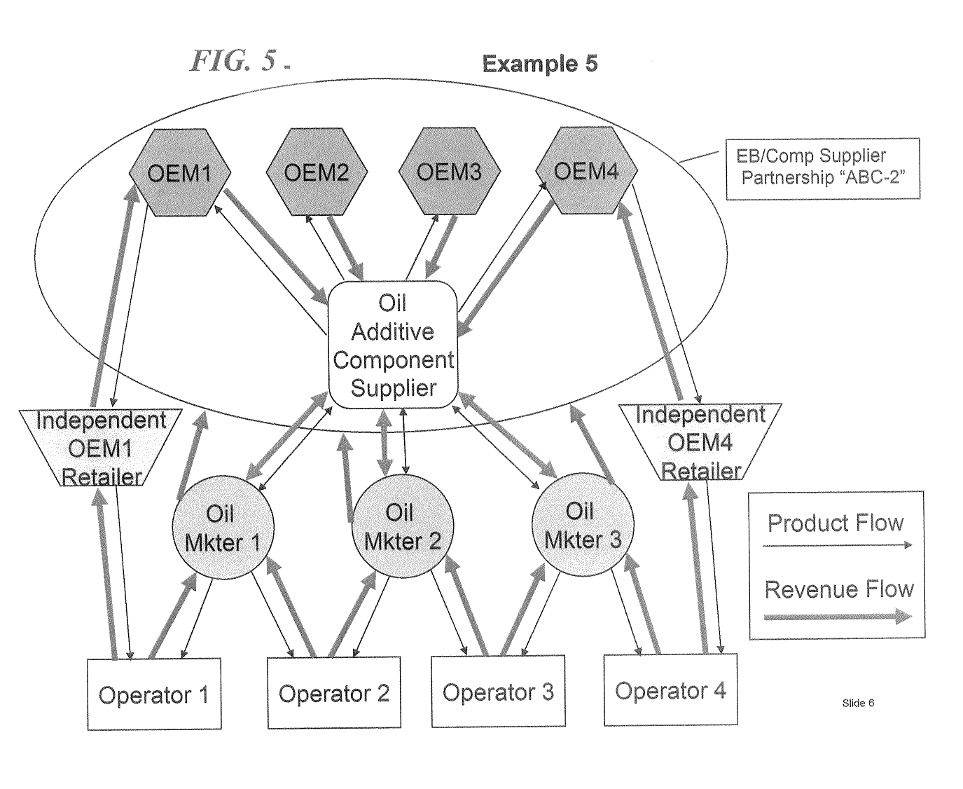

(See FIG. 5) Combines Example 3 and Example 4. The consortium partnership involves a number of equipment manufacturers who seek an arrangement where they receive free factory fill hydraulic fluid from the additive component supplier partner. The consortium selects and endorses a shared specification for the hydraulic fluid. The partnership selects several oil marketers to supply the needs of the OEMs, and also to directly sell the genuine service fill hydraulic fluid endorsed and specified by the equipment manufacturers in the partnership. Bringing the technology to market in a more rapid manner with multiple OEMs and multiple oil marketers can significantly impact the overall productivity of a large number of equipment units, and can also reduces fuel consumption and exhaust emissions.

Obviously, numerous modifications and variations of the present invention are possible in light of the above teachings. It is therefore to be understood that within the scope of the appended claims, the invention may be practiced otherwise than as specifically described herein.

1. A method for commercializing a first consumable product used to operate a capital equipment article, comprising:
selling the first consumable product to at least one of a builder and a supplier of the capital equipment article at a first price P1,
then selling the first consumable product at a second price P2 to the builder and/or the supplier of the capital equipment article, or an equipment purchaser that purchased the capital equipment article from the builder or the supplier through a sales path that is different from the sales path of the first sale of the first consumable product,
wherein the first price P1 does not increase the cost of the capital equipment article in comparison to the price of the capital equipment article sold with a second consumable product, and the second price P2 is an amount sufficient to provide a net profit to a supplier or manufacturer of the first consumable product based on the total cost of the first consumable product,
wherein the capital equipment article is sold by the builder and/or the supplier of the capital equipment article to the equipment purchaser with a first amount of the first consumable product already installed, and
wherein the capital equipment article includes a warranty specification having performance requirements met by the first consumable product.

2. The method of claim 1, wherein the first consumable product is sold to the purchaser of the capital equipment article by the builder or the supplier of the capital equipment article.

3. The method of claim 1, wherein the total amount of the first consumable product that is sold is sufficient to provide a net profit to the seller thereof.

4. The method of claim 1, wherein the first consumable product is sold to a builder or a supplier of capital equipment articles by a supplier of the consumable product and the first consumable product is sold to the purchaser by a retailer or a distributor.

5. The method of claim 4, wherein the first consumable product sold by the retailer or distributor is a product branded with a mark of the supplier of the first consumable product.

6. The method of claim 1, wherein the second price P2 is at least 20% greater than the price at which the second consumable product was sold.

7. The method of claim 6, wherein the first price P1 is less than the price at which the second consumable product was sold to the builder or the supplier of the capital equipment article.

8. The method of claim 1, wherein the builder or the supplier of the capital equipment article (1) purchases the first consumable product from a consumable product supplier at the first price P1 in a first amount sufficient for an initial fill of the capital equipment article, then (2) sells a second amount of the first consumable product to the equipment purchaser at a price P2, wherein the builder or the supplier of the capital equipment article purchases the first and second amounts of the first consumable product at the same price P1 and obtains a rebate from the consumable product supplier for selling an amount of the first consumable product a the sales price P2.

9. The method of claim 1, wherein the capital equipment article includes a warranty specification having performance requirements that are not met by an existing consumable product.

10. The method of claim 1, wherein the profit is the profit to the consumable product supplier.

11. The method of claim 1, wherein the consumable product supplier sells the entire quantity of the first consumable product sold to the builder and/or the supplier of the capital equipment article, and sells the entire quantity of the first consumable product sold to the equipment purchaser.
